(19) United States
(12) Patent Application Publication
(10) Pub. No.: US 2008/0181548 A1
(43) Pub. Date: Jul. 31, 2008

(54) Magnetic Suspension Bearing

(76) Inventor: Chuy-Nan Chio, Taipei (TW)

Correspondence Address: HDSL, 4331 STEVENS BATTLE LANE, FAIRFAX, VA, 22033, US

(21) Appl. No.: 11/913,312

(22) PCT Filed: May 20, 2005
(86) PCT No.: PCT/CN05/00697

§ 371 Date: Nov. 1, 2007

(51) Int. Cl. F16C 32/04; F04D 29/058; F04D 29/048

(52) U.S. Cl. 384/446

(57) ABSTRACT

A magnetic suspension bearing includes an outer layer enclosing a plurality of magnets, an inner layer which enclosing a plurality of magnets, an outer enclosure located at one side of the outer layer and enclosing the outer layer to form a magnetic barrel, and an inner enclosure located at one side of the inner layer and enclosing the inner layer to form a magnetic barrel. when assembling the bearing, the outer layer and the inner layer are assembled together, and the magnets in the inner layer and the outer layer are disposed staggeringly up and down, remaining a gap between each pair of the magnets so as to generate a magnetic suspension force produced from repulsion force between magnets of the same polarity. With this magnetic suspension bearing, the shaft is able to rotate with high speed yet less generation of heat by friction, due to a gap between an upper end and a lower end of the inner and outer layer the magnets therein will not impact each other even if vibration therebetween is more than a limit, and the outer enclosure and the inner enclosure as magnetic barrels encloses the outer layer and the inner layer so that some components are protected from magnetic force generated by the magnets, which improve the durability of the bearing compared with a conventional pivot or ball bearing.

### BACKGROUND OF THE INVENTION

1. Field of the Invention

The present invention relates to a magnetic suspension bearing. More particularly, the present invention relates to a bearing that apply a magnetic suspension force produced from repulsion force between magnets of the same polarity in place of traditional ball bearings to prevent the generation of heat by friction. As a result, the life of the bearings can be enhanced, and the magnets in the inner layer and the outer layer of the bearing are disposed staggeringly up and down or combined by necessity in order to enhance the load of bearings, and thereby the efficiency of the bearings can be improved.

2. Descriptions of the Related Art

As the electric age goes fast, periphery appliances of a computer diversify and make the

As present, the traditional bearings are mostly designed as ball bearings to fix the axis. However, when using a ball bearing, the balls inside the bearing rub against the axis as it rotates, which makes noise. Furthermore, as the axis rubs against the balls, trifles caused by friction spread to other components, and the friction between the axis and the balls also causes heat that reduces the life of the bearing.

In addition, some lubricating oil is usually filled onto the balls to reduce the rotating friction as an improvement to traditional ball bearings. Even so, as the using time gets longer, the lubricating oil mixing with dusts in the air becomes dark and thick, which might stain other components and influence the operation of the whole bearing.

The above proves that the aforementioned prior art is still faulty in many aspects, which is not a well-found design and remains to be improved.

### SUMMARY OF THE INVENTION

The primary objective of the present invention is to provide a magnetic suspension bearing wherein magnets in the inner layer and the outer layer of the bearing are disposed staggeringly up and down, remaining a gap between each pair of the magnets so as to generate a magnetic suspension force produced from repulsion force between magnets of the same polarity. Another objective of the present invention is to provide a magnetic suspension bearing wherein a gap is remained between the inner layer and the outer layer to prevent the magnets from impact on each other when actuating, thus can protect the components of the bearing. Another objective of the present invention is to provide a magnetic suspension bearing in place of traditional bearings to reduce the generation of heat by friction when the bearings are over-actuating, as a result, the life of the bearings can be extended, and the cost of component renewal can be reduced.

Yet another objective of the present invention is to provide a magnetic suspension bearing, wherein with the magnetic suspension force, the bearings don't rub against each other when rotating, thus high-speed driving can be achieved.

The magnetic suspension bearing that can reach the aforementioned objectives contains:

an outer layer which encloses a plurality of magnets;

an inner layer which encloses a plurality of magnet;

an outer enclosure which is located at one side of the outer layer and encloses the outer layer to form a magnetic barrel; and

an inner enclosure which is located at one side of the inner layer and encloses the inner layer to form a magnetic barrel.

The outer layer in the aforementioned magnetic suspension bearing is made of magnetic material.

The inner layer in the aforementioned magnetic suspension bearing is made of magnetic material.

The outer enclosure in the aforementioned magnetic suspension bearing is made of isolation material.

The inner enclosure in the aforementioned magnetic suspension bearing is made of isolation material.

The magnets in the inner layer and the outer layer in the aforementioned magnetic suspension bearing are disposed staggeringly up and down, remaining a gap between each pair of the magnets.

A contactor of the inner layer and a contactor of the outer layer in the aforementioned magnetic suspension bearing correspondingly remain a gap between each other.

The gap between the inner layer and the outer layer in the aforementioned magnetic suspension bearing is small than a gap between each pair of the magnets.

The magnetic suspension bearing provided by the present invention has the advantages as follows:
1. The present invention applies a magnetic suspension force produced from repulsion force between magnets of the same polarity in place of traditional ball bearings to prevent the problems like generation of heat by friction, trifles and noise, which provides higher-speed driving and therefore extends the life of the bearings and other components in the same working situation.
2. The present invention applies a gap remained between a contactor of the inner layer and a contactor of the outer layer correspondingly to prevent the magnet from impact on each other when placing the axis or over-actuating.
3. The present invention applies the outer enclosure enclosing the outer layer and the inner enclosure enclosing the inner layer to form magnetic barrels respectively in order to protect the components from being damaged by magnetism, and to ensure normal operation of the components.

### BRIEF DESCRIPTION OF THE DRAWINGS

The drawings disclose an illustrative embodiment of the present invention which serves to exemplify the various advantages and objects hereof, and are as follows:

FIG. 1 is an exploded diagram of the present invention;

FIG. 2 is a profile of the present invention;

FIG. 3 is an assembly diagram of the present invention;

FIG. 4 is a diagram of embodiment of the present invention;

FIG. 5 is another diagram of embodiment of the present invention; and

FIG. 5A is still another diagram of embodiment of the present invention.

### DESCRIPTION OF THE PREFERRED EMBODIMENT

The structures, using, and characters of the invention, as well as its many advantages, may be further understood by the following detailed description and drawings.

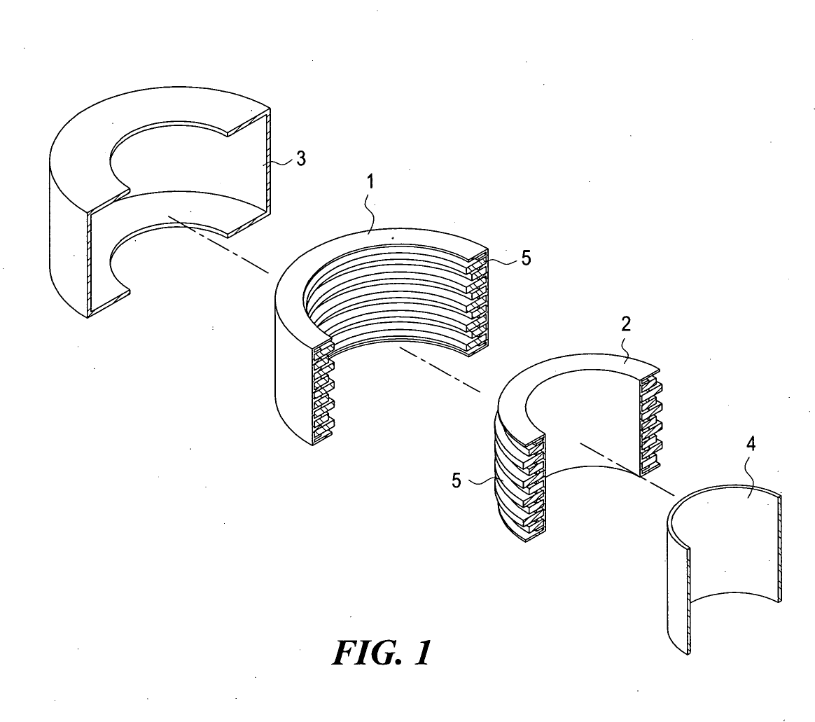

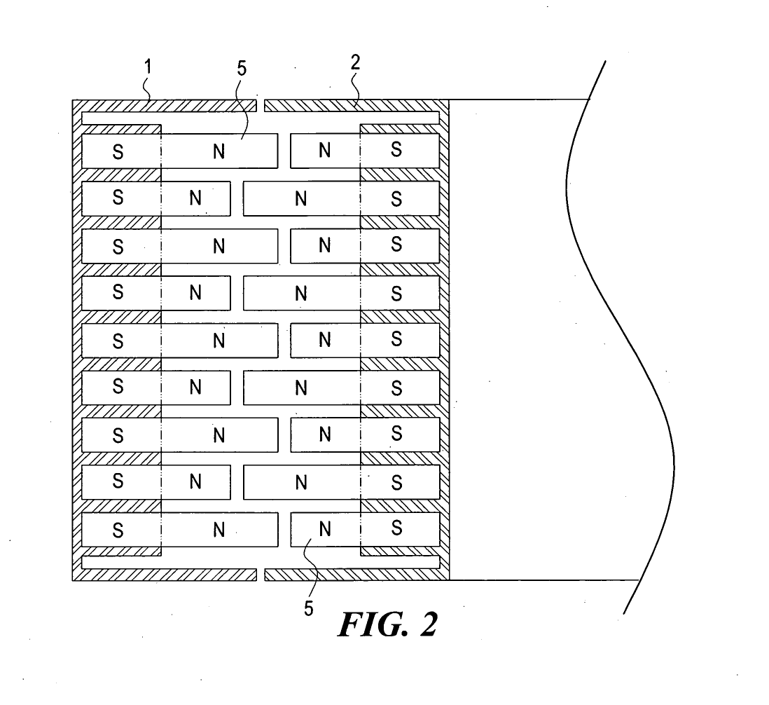

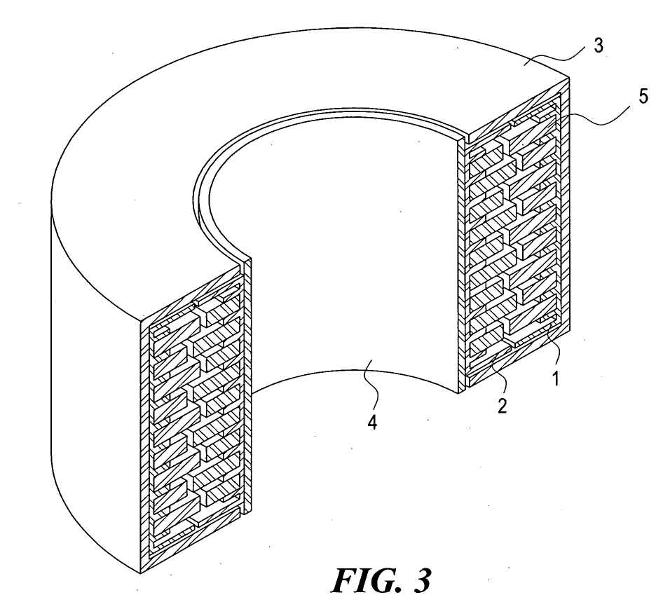

First, referring to FIG. 1, FIG. 2 and FIG. 3, the present invention is a magnetic suspension bearing mainly contains:

an outer layer 1 enclosing a plurality of magnets, which applies the outer layer 1 to entirely enclose the S pole of the magnet 5, exposing the N pole of the magnet 5. (The pole position of the magnet 5 is reversible by necessity.) In addition, the outer layer 1 is made of magnetic material, therefore is conductive to and overspread with magnetism.

an inner layer 2 enclosing a plurality of magnets, which applies the inner layer 2 to entirely enclose the S pole of the magnet 5, exposing the N pole of the magnet 5. (The pole position of the magnet 5 is reversible by necessity.) In addition, the inner layer 2 is made of magnetic material, therefore is conductive and overspread with magnetism. A preferred embodiment of the pole end can be referred to FIG. 2.

an outer enclosure 3 located at one side of the outer layer 1, which is applied to enclose the outer layer 1 to form a magnetic barrel in order to prevent other components from the influence of magnetism; the outer enclosure 3 is made of isolation material;

an inner enclosure 4 located at one side of the outer layer 2, which is applied to enclose the inner layer 2 to form a magnetic barrel in order to prevent the axis from the influence of magnetism; the inner enclosure 4 is made of isolation material.

As in the aforementioned structure, when assembling the suspension bearing, the outer layer 1 and the inner layer 2 are assembled together, and the magnets 5 in the inner layer 2 and the outer layer 1 of the bearing are disposed staggeringly up and down, remaining a gap between each pair of the magnets 5 so as to generate a magnetic suspension force produced from repulsion force between magnets 5 of the same polarity, wherein the magnets 5 respectively belonging to the inner layer 2 and the outer layer 1 don't touch each other, and thus don't rub against each other when the bearing rotates. As a result, the problems of noise and trifles caused from attrition can be improved, and the axis 6 doesn't generate heat by friction as well, which all above can extend the life of the bearing and other components.

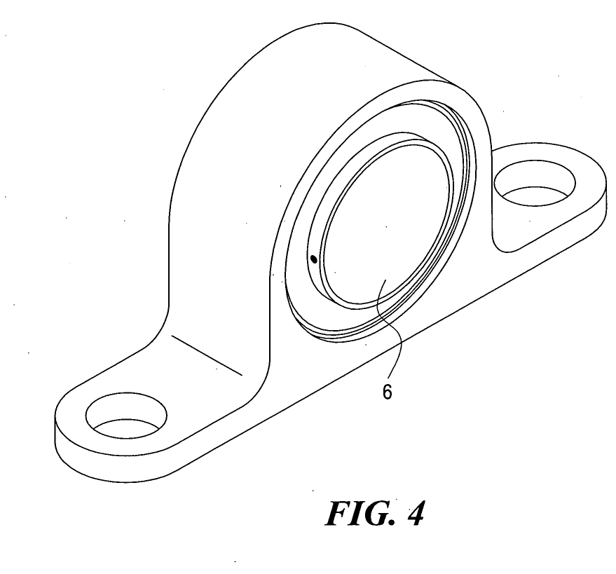

Then, referring to FIG. 2 and FIG. 4, a contactor of the inner layer 2 and a contactor of the outer layer 1 correspondingly remain a gap between each other, which is a little bit smaller than a gap between each pair of the magnets. When placing the axis 6 or when over-actuating, the inner layer 2 is extruded toward the outer layer 1, thus the gap between the upper end and the lower end of the inner layer 2 and the outer layer 1 will touch and withstand mutually and prevent the magnets 5 of the inner layer 2 and the outer layer 1 from impacting each other, which protects the magnets 5 and furthermore protect the components of the bearing as well.

Besides, as the outer enclosure 3 encloses the outer layer 1 on the outer side and the inner enclosure 4 encloses the inner layer 2 on the inner side to insulate the magnetism of the magnets 5 of the outer layer 1 and the inner layer 2 respectively, the magnetism will not be conducted to other components of the bearing in order to protect the rotating of the components from being damaged by magnetism, and to ensure normal operation of the components.

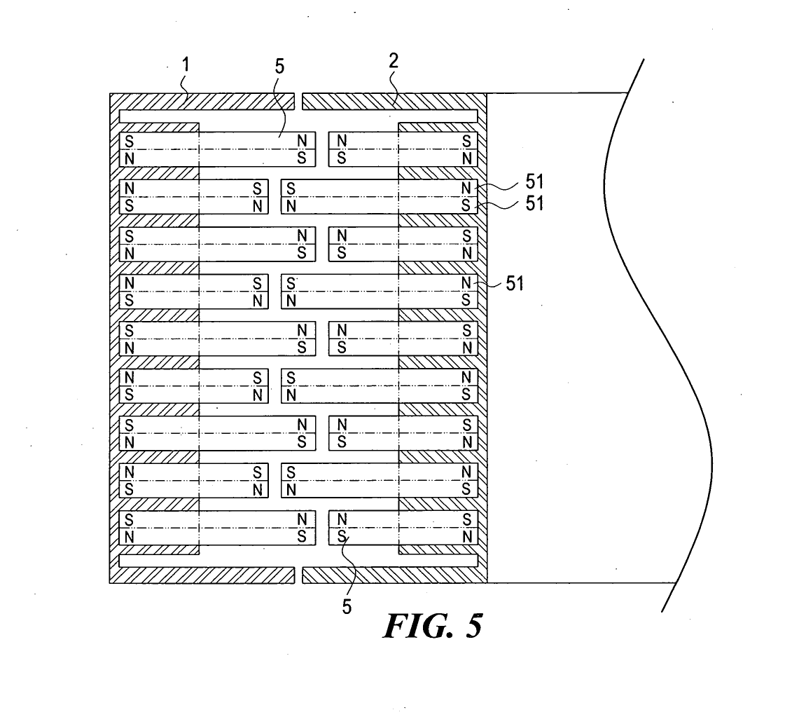

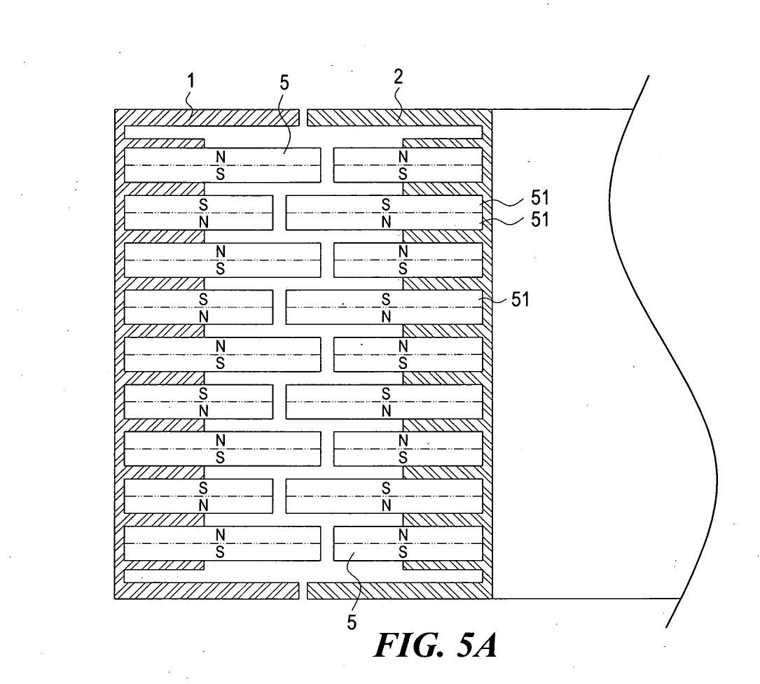

Moreover, the pole end 51 of the magnet 5 still comprises other preferred embodiments as shown in FIG. 5 and FIG. 5A, also applying the magnetic suspension force produced from repulsion force between magnets 5 of the same polarity.

The magnetic suspension bearing provided by the present invention applies a magnetic suspension force produced from repulsion force between magnets of the same polarity in place of traditional ball bearings to prevent the problems like noise, trifles and generation of heat by friction, which provides higher-speed driving and therefore extends the life of the bearings and other components in the same working situation. The present invention also applies a gap remained between a contactor of the inner layer and a contactor of the outer layer correspondingly to prevent the magnet from impact on each other when placing the axis or over-actuating. The present invention is liable to industrial production with an extensive prospect of application.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A magnetic suspension bearing, comprising:
an outer layer enclosing a plurality of magnets;
an inner layer enclosing a plurality of magnets;
an outer enclosure being located at one side of the outer layer and enclosing the outer layer to form a magnetic barrel; and
an inner enclosure being located at one side of the inner layer and enclosing the inner layer to form a magnetic barrel.

2. The magnetic suspension bearing as claimed in claim 1, wherein the outer layer is made of magnetic material.

3. The magnetic suspension bearing as claimed in claim 1, wherein the inner layer is made of magnetic material.

4. The magnetic suspension bearing as claimed in claim 1, wherein the outer enclosure is made of isolation material.

5. The magnetic suspension bearing as claimed in claim 1, wherein the inner enclosure is made of isolation material.

6. The magnetic suspension bearing as claimed in claim 1, wherein the magnets in the inner layer and the outer layer are disposed staggeringly up and down, remaining a gap between each pair of the magnets.

7. The magnetic suspension bearing as claimed in claim 1, wherein a contactor of the inner layer and a contactor of the outer layer correspondingly remain a gap between each other.

8. The magnetic suspension bearing as claimed in claim 8, wherein the gap between the inner layer and the outer layer is smaller than a gap between each pair of the magnets.
